(19) United States
(12) Patent Application Publication
(10) Pub. No.: US 2005/0104268 A1
(43) Pub. Date: May 19, 2005

(54) Centering and/or clamping device for work pieces, having an actuation module

(75) Inventor: Luciano Migliori, Milan (IT)

Correspondence Address: YOUNG & THOMPSON, 745 SOUTH 23RD STREET, 2ND FLOOR, ARLINGTON, VA, 22202, US

(73) Assignee: UNIVER S.P.A., MILAN (IT)

(21) Appl. No.: 10/988,627

(22) Filed: Nov. 16, 2004

(30) Foreign Application Priority Data
Nov. 17, 2003 (IT) MI2003A 002226
Nov. 17, 2003 (IT) MI2003A 002228

(51) Int. Cl. B23Q 1/00

(52) U.S. Cl. 269/47

(57) ABSTRACT

A centering and/or clamping device for work pieces includes an operative unit including a first box-shaped body for supporting a movable retaining member for centering and/or clamping the work pieces, and sensing elements for detecting the position of the retaining member; the device also includes an actuation unit operatively coupled with the operative unit, which includes a second box-shaped body housing an electronic control unit and a supporting frame for supporting control elements of the retaining member. The operative unit and the actuation unit, which can be mechanically and electrically disengageably coupled together, are provided with disengageable electrical connecting elements, for connecting the detecting sensor, and, respectively, the control elements to the electronic control unit.

### BACKGROUND OF THE INVENTION

This invention concerns a centering and/or clamping device for work pieces, used in particular for centering and/or clamping sheet metal parts in the vehicle body construction.

For the purposes of the present description, the term “retaining member” is used to indicate any movable member of the above devices suitably conformed for retaining, centering and/or clamping a workpiece.

### STATE OF THE ART

In the automotive field, and in particular in the construction of vehicles body, it is necessary to use a plurality of devices for centering and/or clamping sheet metal parts which are to be assembled or welded together.

Along a production line for motor vehicles, different types of the above devices are used, depending upon their specific function, and in particular use can be made of centering devices, clamping devices, and underbody devices for retaining, centering and clamping work pieces.

A device for centering work pieces, for example described in EP 1 123 779, generally comprises a box-shaped body for supporting an axially movable retaining member for retaining and centering workpieces, which protrudes from one end of the same box-shaped body. The centering device also comprises control means operatively connected to the retaining member, which in turn can comprise an electric motor, a drive mechanism designed to transform the rotary movement of the motor into an axial movement of an actuating element for actuating the retaining member, and an electronic control unit.

A clamping device for clamping work pieces, for example described in WO 99/50944 and EP 243 599, generally comprises a box-shaped body to which a retaining member is pivotally connected, the retaining member being designed to perform a rotational movement between an open raised position for releasing a work piece, and a closed lowered position for clamping a work piece against an anvil or other supporting structure.

The retaining member is operatively connected to control means, which, as in the case of the centering device, can comprise an electric motor, a drive mechanism between the electric motor and an axially movable actuating element connected to the retaining member by a toggle-lever mechanism, and an electronic control unit.

Lastly, an underbody centering and clamping device is commercially known, which comprises a box-shaped body preferably supporting a hollow centering pin, from a side of which a hook-shaped retaining member protrudes, said hook member being movable between a forward position for releasing and a backward position for retaining a work piece.

The retaining member in this case is operatively connected to control means comprising electrically or pneumatically-controlled linear actuating means, a toggle-lever mechanism and an articulated quadrilateral system.

In general, in the above different centering and/or clamping devices, the control means are the components most subject to failure or malfunctioning; in fact the mechanical members of the control means are subject to the greatest stresses, in particular fatigue stresses, while the electric components of the control means can operate irregularly or break down, for example owing to overheating of the motor or oxidization of contacts.

Whenever a failure or malfunctioning of the control means of such devices occurs, it is necessary to stop the production or the assembling line in order to replace the parts affected by the failure; therefore, it is obvious that a reduction in the times required for maintenance and operations on the centering and/or clamping devices allows a reduction in the costs related to the interruption of the work cycle carried out by the production lines.

However, in the centering and/or clamping devices of conventional type, such as for example in EP 1 123 779, the disassembling and replacement of the parts of the control means affected by the failure does not always prove to be fast and easy to carry out, in that it is necessary to firstly remove a certain number of mechanical components in order to carry out the repair.

A further drawback of the centering and/or clamping devices of this type is that the electronic control unit is housed in a box arranged outside the same device, or in a separate external cabinet which contains the control units of a plurality of devices, as illustrated for example in WO 99/50944.

Such arrangements of the control unit involve dimension problems, in that the presence of the box on the outside of the device or of the cabinet containing the control units limits the movement freedom near of the individual devices or along the production lines; moreover, whenever a cabinet containing the control units is provided, it is necessary to arrange a series of electric conductors, both for the input, and for the signal transfer to and from the various devices, involving the risk that they may be subject to electromagnetic interferences, deriving from electric actuators of the production line, which are liable to affect the efficient operation of the centering and/or clamping devices.

### OBJECTS OF THE INVENTION

The main object of this invention is to provide centering and/or clamping devices of the aforementioned types, which are structurally simple, and which have limited overall dimensions allowing to have high available space for movement of workpieces and of equipments near the same devices and along the production line, with a consequent greater versatility in the use of the devices.

A further object of this invention is to provide centering and/or clamping devices of the aforementioned type, which have a structure allowing fast and easy repair and maintenance operations, limiting the stop periods of the functioning of the production lines, thereby achieving a reduction in the operating costs of the plant.

Another object of this invention is to provide centering and/or clamping devices of the aforementioned types, which operate reliably and regularly also in the presence of electromagnetic fields emitted from other apparatuses of the production lines.

Another further object of this invention is to provide a centering device for work pieces of the aforementioned type, which is simply adjustable in order to have different working strokes for the retaining member, starting from a single centering device, depending upon work requirements.

### BRIEF DESCRIPTION OF THE INVENTION

More precisely, according to the invention a clamping and/or centering device has been provided, comprising:
an operative unit including a first box-shaped body and a retaining member movably supported by said box-shaped body, and sensing means providing electric control signals in at least one operative position of the retaining member;
an actuation unit including a second box-shaped body, a support frame and control means on said support frame inside the second box-shaped body, said control means comprising at least one electric motor and a geared drive mechanism disposed between the electric motor and the retaining member; and
an electronic control unit, the electronic control unit being housed inside the box-shaped body of the actuation unit;
said operative unit and said actuation unit comprising disengageable electrical connectors between the control unit, the electric motor and said sensing means;
said operative unit and said actuation unit being in the form of mechanically and electrically disengageable modular unit.

### BRIEF DESCRIPTION OF THE DRAWINGS

These and further features according to this invention, will be more clearly evident from the following description with reference to the accompanying drawings, in which:

FIG. 1 shows a longitudinal cross-sectional view of a centering device for centering work pieces according to a first embodiment of the invention, along the line 1-1 of FIG. 2;

FIG. 2 shows a longitudinal cross-sectional view of the centering device of FIG. 1, along the line 2-2 of FIG. 1;

FIG. 3 shows a plan view of the box-shaped body for housing the control means of the device;

FIG. 4 shows a perspective view of a detail of the device of FIG. 1, with the box-shaped body for housing the control means partially removed;

FIG. 5 shows a perspective view of the device of FIG. 1, showing the supporting frame for supporting the control means;

FIG. 6 shows a longitudinal cross-sectional view of a clamping device for clamping work pieces according to a second embodiment of the invention;

FIG. 7 shows a longitudinal cross-sectional view of an underbody centering and clamping device for centering and clamping work pieces according to a third embodiment of the invention.

### DETAILED DESCRIPTION OF THE INVENTION

The general features of this invention will be illustrated hereunder by means of several embodiments.

The figures from 1 to 5 show a first embodiment of a centering device for centering work pieces according to the invention; said device comprises a first operative unit 10 which includes a first box-shaped body 11, having its own longitudinal axis, which supports a movable retaining member, in this case a centering member 12, which protrudes from one end of the same box-shaped body 11.

The centering member 12 in particular is in the form of a rod slidingly supported by the box-shaped body 11 to perform an axial movement between a backward position in which it disengages and a forward operative position in which it engages with a work piece, along a working stroke.

The centering device also comprises a second actuation unit 13 operatively coupled to the first, which comprises a supporting frame 14 for supporting control means operatively connected with the centering member 12.

The control means in turn comprise at least one electric motor 15, having its own drive shaft 15′, and a geared drive mechanism 16 disposed between the electric motor 15 and the centering member 12 of the first operative unit 10; the drive mechanism 16 in particular transforms the rotary movement of the electric motor drive shaft 15′ into an axial movement of a thrust member 17 of said drive mechanism 16, operatively connected to the centering member 12.

The supporting frame 14 for the control means in turn comprises a base plate 14′, to which the electric motor 15 in fastened, on a front side of the base plate 14′ facing the first operative unit 10. The supporting frame 14 further comprises and hollow upright member 14″ which extends on the front side of the base plate 14′, the up right member 14″ ending with a top plate 14′″ of the supporting frame 14 which is secured to the box-shaped body 11 of the first operative unit 10 by a plurality of anchor bolts 19, preferentially with the interposition of a closing plate 18 secured to the box-shaped body 11.

The second actuation unit 13 also comprises a second box-shaped body 20 for housing the supporting frame 14 and the aforesaid control means, which has one end secured, by means of appropriate tie rods 20′, to the box-shaped body 11 of the first operative unit 10 or to the closing plate 18 interposed between the box-shaped body 11 and the same supporting frame 14.

The first operative unit 10 comprises sensing means, in this case a first and a second sensor 21, 22, respectively providing electric control signals of the forward and of the backward positions of the centering member 12, which are preferentially supported in adjustable positions in the axial direction by a housing box C fastened to the box-shaped body 11 of the first operative unit 10.

The device comprises an electronic control unit 23′, 23″ housed and secured inside the box-shaped body 20 of the second actuation unit 13; preferentially the electronic unit comprises a first electronic printed circuit 23′, housed at an opposite end of the box-shaped body 20 in respect to the first operative unit 10 securing end, and a second electronic printed circuit 23″, disposed longitudinally along a side of the box-shaped body 20 of the second actuation unit 13.

The housing box C for the sensors 21, 22 preferentially comprises an interface circuit I between the sensors 21, 22 and the electronic control unit 23′, 23″.

The first operative unit 10 and the second actuation unit 13 are in the form of corresponding modular units which can be mechanically and electrically disengageably coupled with each other; in particular the operative unit 10 and the actuation unit 13 are provided with disengageable connecting means, arranged inside the box-shaped body 20 o the actuation unit 13. The connecting means preferentially comprise electrical connecting elements 24′, 24″ and 25′, 25″, between the electronic control unit 23′, 23″ and the electric motor 15, respectively the detecting sensor 21, 22, in order to connect the detecting sensors 21, 22 and, respectively, the electric motor 15 to the same electronic control unit 23′, 23″.

In this way, in the event of failure or malfunctioning, it is possible to quickly replace the electronic control unit 23′, 23″ by removing the box-shaped body 20 of the second modular actuation unit 13 and replacing it with another having a new electronic unit 23′, 23″ correctly operating.

On the contrary, whenever it is necessary to replace the control means, it is sufficient to remove the supporting frame 14 of the control means from the first modular operative unit 10, after having removed the box-shaped body 20 of the second modular unit 13.

This facilitates the maintenance operations on the centering devices, thereby limiting the operating times and relevant costs.

Moreover, the fact of housing the electronic control unit 23′, 23″ inside the device itself, allows both a reduction in the overall dimensions, thereby offering a greater movement freedom near the centering devices and/or along the production lines, and a limitation in the electromagnetic interferences on the device, thanks to the shielding action performed by the box-shaped body 20 housing the control unit 23′, 23″.

The drive mechanism 16 of the control means comprises a gear set 26 for connection between the shaft 15′ of the electric motor 15 and a drive axis 29′ operatively connected to the thrust member 17 for the centering member 12.

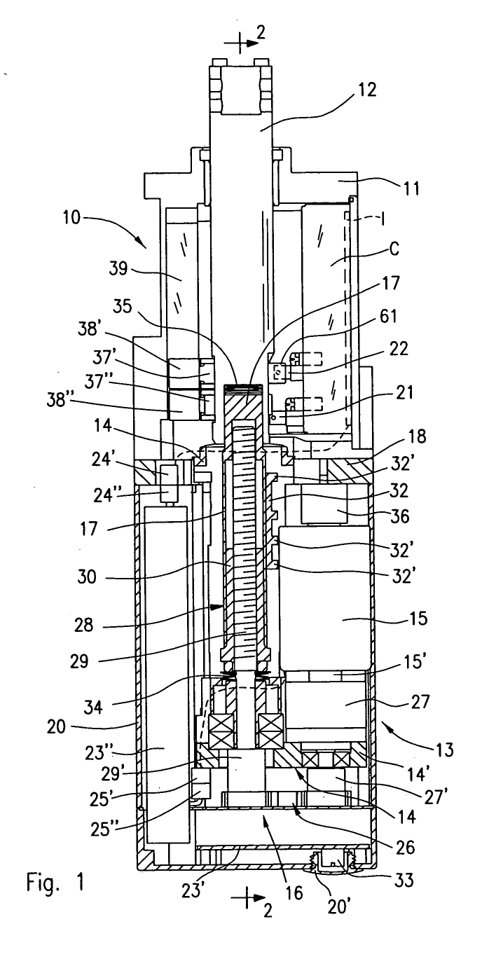

The drive mechanism 16 preferentially comprises a reduction gear 27, for example of the epicyclic type, connected between the shaft 15′ of the electric motor 15 and the gear set 26. In this case, the gear set 26 will be operatively connected to an output axis 27′ of the same reduction gear 27, as illustrated in FIGS. 1 and 5.

As shown in FIG. 5, preferentially the output axis 27′ of the reduction gear 27 and the drive axis 29′ extend through appropriate holes 55, 56 in the base plate 14′ of the supporting frame 14, in such a way that the gear set 26 can be arranged on a rear side of the same base plate 14′, in a more accessible position for any maintenance operation.

The gear set 26 preferentially comprises a first gear 26′, connected to the output axis 27′, a second intermediate gear 26″ and a third gear 26′″ connected to the drive axis 29′.

The drive mechanism 16 also comprises a screw-nut system 28 which operatively connects the centering member 12 with the gear set 26 of the control means. In particular, the system 28 comprises a screw 29 connected with the gear set 26 via the drive axis 29′, and a nut screw 30 which prolongs in the thrust member 17 of the centering member 12.

The screw 29 and the nut screw 30 of the screw-nut system 28 are disengageably coupled together for removal of the second modular unit 13 from the first modular unit 10.

As shown in FIG. 3, the device comprises an electric connector 31 for connection with an external power supply, not shown, the connector 31 being supported by an outer wall of the second box-shaped body 20 of the second modular unit 13; preferentially, the box-shaped body 20 of the second unit 13, in cross section, is rectangularly shaped having a recessed corner for housing the electrical connector 31 and an electrical conductor which connects it with the external power supply.

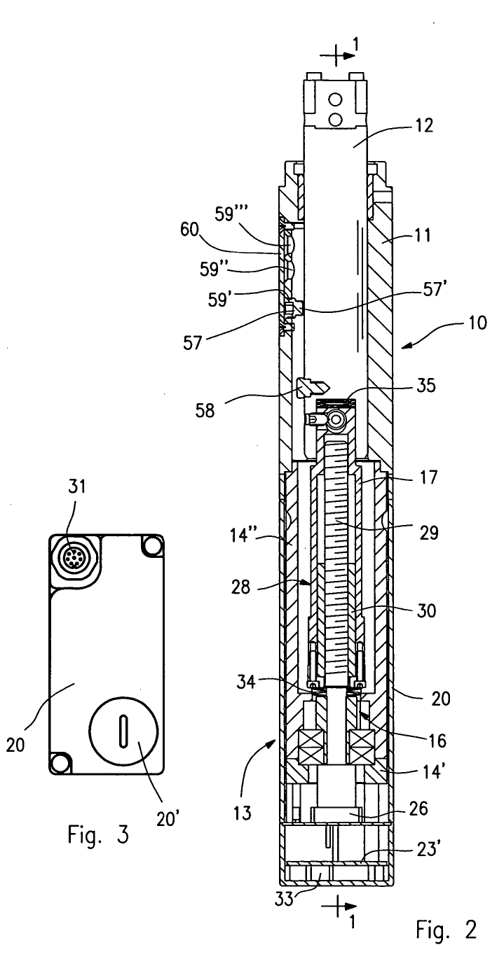

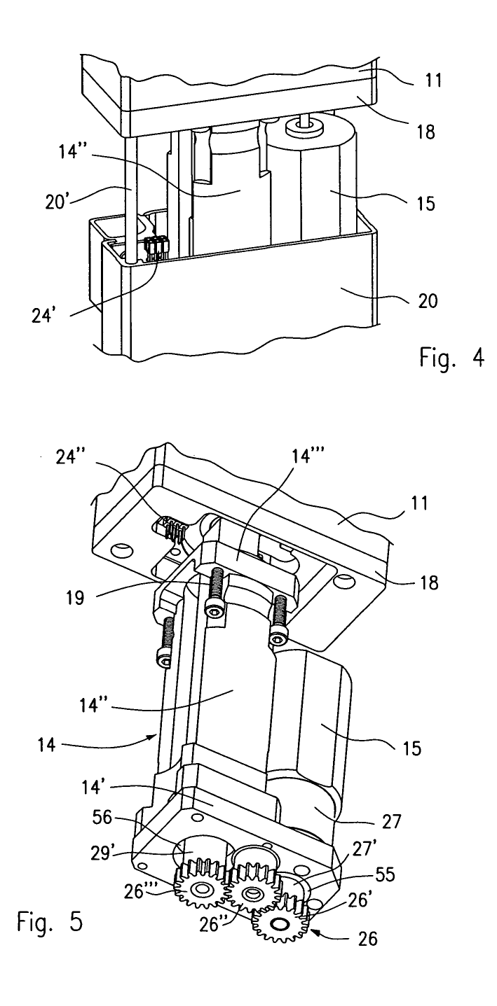

As shown in FIGS. 1 and 2, the centering device according to this invention can comprise adjustable means for limiting the working stroke of the centering member 12, which comprise a stop member 57 which can be selectively positioned in different stop positions axially aligned along a side of the box-shaped body 11, and a protruding member 58 connected to a side of the centering member 12, designed to come into contact with the aforesaid stop member 57.

Preferentially, the stop member 57 can be screwed into a plurality of threaded through holes 59′, 59″, 59′″ provided in a side wall of the box-shaped body 11, which are aligned according to the longitudinal axis of the same box-shaped body 11, and are protected by an appropriate cover 60.

The stop member 57 extends towards the centering rod 12 with an extension 57′ which comes into contact with the protruding member 58 when the centering member 12 comes to a forward position in which it engages the work piece.

Thanks to these means, depending upon the requirements of use of the device, it is consequently possible to limit the working stroke of the centering member 12, stopping it in different positions corresponding to different forward positions in which it engages the work piece.

Once a forward stopping position of the centering member 12 has been established, the stop member 57 is inserted into a corresponding threaded hole 59′, 59″, 59′″, so that it can come into contact with the protruding member 58 connected to the centering member 12, stopping its stroke when the established forward position has been reached.

The device comprises an activation member 32 for the sensor 21 for detecting the forward position of the centering member 12, supported by the thrust member 17 of the centering member 12, the activation member 32 which comprising a plurality of longitudinally spaced apart side protrusions 32′, each corresponding to a different operative position of the centering member 12.

The sensor 22 for the detecting the backward position of the centering member 12 is instead activated by a protrusion 61 connected to the same centering member 12.

The electronic control unit 23′, 23″ comprises a switch device 33 selectively operatable from the outside, for example from an aperture of the second box-shaped body 20 which can be closed by a plug 20′, the switch device 33 being designed to set a program the control unit 23′, 23″ to cut off the power supply to the electric motor 15 in correspondence with a corresponding operative position of the centering member 12 detected by the sensor 21.

In particular, the switch device 33 allows to select the signals emitted by the sensors 21, 22, in order to pre-set the operation of the electronic control unit 23′, 23″, so that one of the control signals provided by the different protrusions 32′ of the activation member 32, in relation to the different positions of the stop member 57, is considered as a control signal for stopping the motor 15.

The centering device preferentially comprises first elastically compressible shock absorbing means 34 supported by the supporting frame 14 of the electric motor 15 and of the drive mechanism 16; in particular, said elastically compressible means 34, for example in the form of Belleville washers, are constructed and disposed circumferentially around the screw 29 of the screw-nut system 28 to counteract the motion of the nut screw 30 close to its backward position in which it engages with the screw 29.

Moreover, the centering device can preferentially comprise second elastically compressible shock absorbing means 35 disposed between the thrust member 17 of the centering member 12 and the same centering member 12.

Said first and second shock absorbing means 34 and 35 allow to limit the stresses acting upon the internal members of the device during the transient states of starting up and stopping of the electric control motor 15.

Preferentially the second actuation unit 13 can be provided with an electric braking device 36 for braking the electric control motor 15, in order to block the centering member 12 in position.

As shown in FIG. 1, the centering member 12 comprises means for preventing its rotation according to its own longitudinal axis, which preferentially comprise a first and a second transversal pin 37′, 37″ for respectively supporting a first and a second guide roller 38′, 38″, sliding along a longitudinal slide track 39 provided in the box-shaped body 11 of the device.

In order to take-up any slack in the coupling between the rollers 38′, 38″ and the slide track 39, one of the pins 37″ is provided with an eccentric end supporting the respective roller 38″, in such a way that by appropriately rotating the same pin 37″, it is possible to maintain the roller 38″, and consequently also the roller 38′, in contact with the aforesaid track 39.

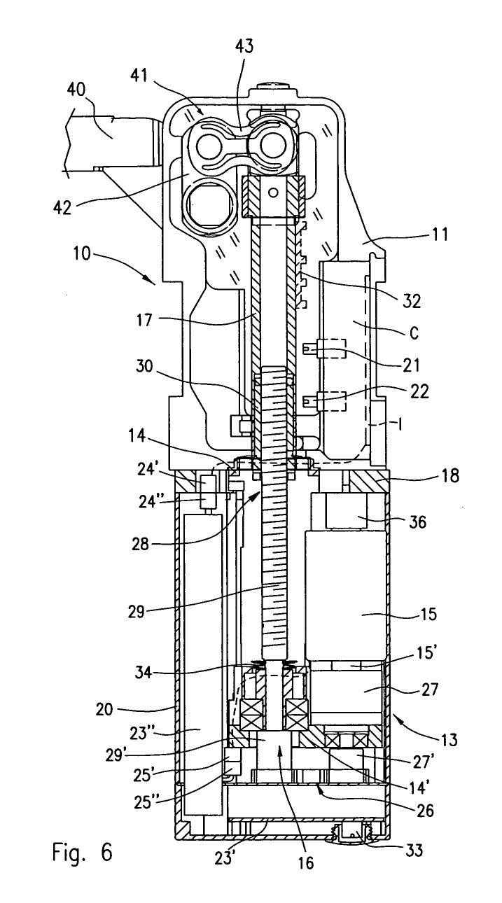

A second embodiment of the centering and/or clamping device is shown in FIG. 6, in which the same reference numbers have been used to indicate similar or equivalent parts.

In such embodiment, the centering and/or clamping device is in the form of a toggle-lever clamping device for clamping work pieces, again comprising a first operative unit 10 and a second actuation unit 13 operatively coupled to the first.

The second actuation unit 13 has characteristics similar to those of the previous embodiment, while the first operative unit 10 includes a first box-shaped body 11, having its own longitudinal axis, which in this case pivotally supports a retaining member 40 performing an angular movement between an open position and a closed position to clamp a work piece against an anvil or other supporting structure.

The retaining member 40 is operatively connected with the control means of the second actuation unit 13 by a toggle-lever mechanism 41, which comprises a crank 42, rotating with the retaining member 40, and a connecting link 43, preferentially of the elastically yieldable type, configured to be yieldable in to the longitudinal direction of the same connecting link 43; the connecting link 43 comprises a first and a second pivoting ends connected together by two side arms elastically yielding in an axial direction, the pivoting ends also comprising respective spaced apart stop means arranged to limit the axial compression of the same connecting link 43, upon reaching and overcoming a dead centre condition of the toggle-lever mechanism 41. The connecting link 43 in particular is pivoted with the aforesaid crank 42 and respectively with an axially movable thrust member 17 operatively connected to the control means of the second actuation unit 13.

Also in this embodiment, the second actuation unit 13 comprises a supporting frame 14 for the control means, which is secured to the box-shaped body 11 of the first operative unit 10.

The second actuation unit 13 also comprises a second box-shaped body 20 for housing the supporting frame 14 of the control means, which is secured, at one of its ends, to the box-shaped body 11 of the first operative unit 10 or to a closing plate 18 interposed between the box-shaped body 11 and the supporting frame 14 itself.

The first operative unit 10 comprises at least one sensor 21, 22, providing electric control signals of an operative position of the retaining member 40, which are supported preferentially by a housing casing C.

The device comprises an electronic control unit 23′, 23″ housed and secured inside the box-shaped body 20 of the second actuation unit 13; preferentially the electronic unit comprises a first electronic printed circuit 23′, housed at an end of the box-shaped body 20 opposite to the end to which the first operative unit 10 is secured, and a second electronic printed circuit 23″, disposed longitudinally along a side of the box-shaped body 20 of the second actuation unit 13.

The first operative unit 10 and the second actuation unit 13 also in this case are in the form of corresponding modular units which can be mechanically and electrically disengageably coupled with each other; in particular, the operative unit 10 and the actuation unit 13 are provided with disengageable electrical connecting elements 24′,24″, 25′, 25″, to connect the detecting sensors 21, 22, and, respectively, the electric control motor 15 to the electronic control unit 23′, 23″.

In this way, in the event of failure or malfunctioning, it is possible to quickly replace the electronic control unit 23′, 23″ by removing the box-shaped body 20 of the second modular unit 13 and replacing it with another having a new electronic unit 23′, 23″ operating correctly.

On the contrary, whenever it is necessary to replace the control means, it is sufficient to remove the supporting frame 14 of the control means from the first modular unit 10, after having removed the box-shaped body 20 of the second modular unit 13.

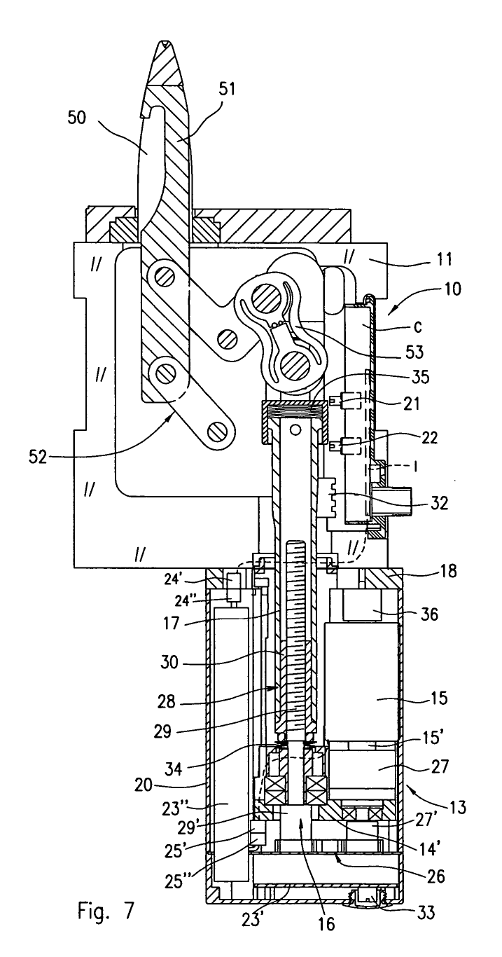

A further embodiment is shown in FIG. 7, in which the same reference numbers have been used to indicate similar or equivalent parts.

This embodiment concerns an underbody device for centering and clamping work pieces, again comprising a first operative unit 10 and a second actuation unit 13 operatively coupled to the first.

The second actuation unit 13 has characteristics similar to those of the previous embodiments, while the first operative unit 10 includes a first box-shaped body 11, which in this case supports, at its front end, a centering pin 50, from which protrudes a hook-shaped retaining member 51, movable between a forward position for releasing and a backward position for retaining a work piece.

The retaining member 51 is supported by the box-shaped body 11 by means of an articulated quadrilateral system 52, which is operatively connected with the control means of the second actuation unit 13 by means of an intermediate connecting link 53 of a toggle-lever mechanism, preferentially of the controlled elastically yieldable type, and an axially movable thrust member 17.

The second actuation unit 13 again comprises a supporting frame 14 for supporting the control means, which is secured to the box-shaped body 11 of the first operative unit 10.

The second actuation unit 13 also comprises a second box-shaped body 20 for housing the supporting frame 14 of the control means, which is secured, at one of its ends, to the box-shaped body 11 of the first operative unit 10 or to a closing plate 18 interposed between the box-shaped body 11 and the supporting frame 14 itself.

The first operative unit 10 again comprises at least one sensor 21, 22 providing electric control signals of an operative position of the retaining member 51, which are preferentially supported by a housing box C.

The device comprises an electronic control unit 23′, 23″ housed and secured inside the box-shaped body 20 of the second actuation unit 13; preferentially the electronic unit comprises a first electronic printed circuit 23′, housed at an end of the box-shaped body 20 opposite to the end at which it is secured to the first operative unit 10, and a second electronic printed circuit 23″, disposed longitudinally along one side of the box-shaped body 20 of the second actuation unit 13.

The first operative unit 10 and the second actuation unit 13 also in this case define corresponding modular units which can be mechanically and electrically disengageably coupled with each other; in particular the operative unit 10 and the actuation unit 13 are provided with disengageable electrical connecting elements 24′, 24″, 25′, 25″, for connecting the detecting sensors 21, 22, and, respectively, the electric control motor 15 to the electronic control unit 23′, 23″.

From the foregoing it will be clear that a centering and/or clamping device according to the invention enables a considerable reduction in production costs in that the single control unit is suitable for assembling different types of devices.

What has been described and shown with reference to the accompanying drawings, has been given purely by way of example in order to illustrate the general features of the invention, as well as several of its preferential embodiments; therefore other modifications and variations to the centering and/or clamping device are possible, without thereby deviating from the scope of the claims.

1. Clamping and/or centering device, comprising:
an operative unit including a first box-shaped body and a retaining member movably supported by said box-shaped body, and sensing means providing electric control signals in at least one operative position of the retaining member;
an actuation unit including a second box-shaped body, a support frame and control means on said support frame inside the second box-shaped body, said control means comprising at least one electric motor and a geared drive mechanism disposed between the electric motor and the retaining member; and
an electronic control unit, the electronic control unit being housed inside the box-shaped body of the actuation unit;
said operative unit and said actuation unit comprising disengageable electrical connectors between the control unit, the electric motor and said sensing means;
said operative unit and said actuation unit being in the form of mechanically and electrically disengageable modular unit.

2. Centering and/or clamping device according to claim 1, in which the drive mechanism comprises an axially movable thrust member operatively connected with the retaining member, wherein said drive mechanism comprises a gear set between the electric motor and the thrust member of the retaining member.

3. Centering and/or clamping device according to claim 2, wherein said drive mechanism comprises a reduction gear connected between the electric motor and the thrust member of the retaining member.

4. Centering and/or clamping device according to claim 3, wherein said reduction gear is of the epicyclic type.

5. Centering and/or clamping device according to claim 2, wherein the drive mechanism comprises a screw-nut system which operatively connects said retaining member with said gear set, the screw of the screw-nut system being connected with said gear set, and the nut screw prolonging in said thrust member for the retaining member,
the screw and the nut screw of the screw-nut connecting system being disengageably coupled together for the removal of the second modular unit from the first modular unit.

6. Centering and/or clamping device according to claim 1, comprising an electric connector for connection with an external power supply, said electric connector being supported by an outer wall of said second box-shaped body of the second modular unit.

7. Centering and/or clamping device according to claim 1, comprising an activation member for the position control sensor, supported by the thrust member of the retaining member, said activation member comprising a plurality of side protrusions spaced apart from one another, each protrusion corresponding to a different operative position of the retaining member,
the electronic control unit comprising a switch device selectively operatable to set the control unit to interrupt the power supply to the electric motor in correspondence with an operative position of the retaining member detected by said sensor.

8. Centering and/or clamping device according to claim 5, comprising first elastically compressible shock absorbing means supported by said supporting frame, the first elastically compressible means being constructed and disposed circumferentially around the screw of the screw-nut system to counteract the motion of the nut screw close to its backward position in which it engages with the screw.

9. Centering and/or clamping device according to claim 1, comprising second elastically compressible shock absorbing means disposed between said thrust member and the retaining member, or a toggle-lever mechanism of the retaining member for work pieces.

10. Centering and/or clamping device according to claim 1, comprising an electric braking device for braking the electric control motor.

11. Centering and/or clamping device according to claim 1, being in the form of a centering device for centering work pieces.

12. Centring device for work pieces according to claim 11, in which the retaining member is in the form of a centring rod axially sliding along a working stroke between a backward position and a forward position, comprising:
adjustable means for limiting the working stroke of the centring rod, said limiting means comprising a stop member which can be selectively positioned in different stop positions axially aligned along the box-shaped body, and a protruding member connected to a side of the centring rod designed to come into contact with said stop member,
the electronic control unit being programmed to stop the electric control motor in relation to the signals emitted by the sensors, in correspondence with the selected stop position of said stop positions of the centring rod.

13. Centring device for work pieces according to claim 12, wherein said stop member can be screwed into a plurality of threaded through holes provided in a side wall of said box-shaped body, said threaded holes being aligned according to the longitudinal axis of the box-shaped body,
said stop member extending towards said centring rod.

14. Centering device according to claim 11, comprising means constructed and arranged for preventing the rotation of the centering member along its longitudinal axis, said means comprising a first and a second transversal pin for supporting respectively a first and a second guide roller sliding along a longitudinal slide track on the box-shaped body of the device, one of said rollers being eccentrically supported on the respective pin.

15. Centering and/or clamping device according to claim 1, being in the form of a clamping device for clamping work pieces.

16. Centering and/or clamping device according to claim 1, being in the form of a centering and clamping device for centering and clamping work pieces.

17. Centering and/or clamping device according to claim 3, wherein the drive mechanism comprises a screw-nut system which operatively connects said retaining member with said gear set, the screw of the screw-nut system being connected with said gear set, and the nut screw prolonging in said thrust member for the retaining member,
the screw and the nut screw of the screw-nut connecting system being disengageably coupled together for the removal of the second modular unit from the first modular unit.
